(19) United States
(12) Patent Application Publication
(10) Pub. No.: US 2013/0204614 A1
(43) Pub. Date: Aug. 8, 2013

(54) REQUEST ACQUISITION SUPPORT SYSTEM IN SYSTEM DEVELOPMENT, REQUEST ACQUISITION SUPPORT METHOD AND RECORDING MEDIUM

(71) Applicant: Eiji Hirao, Tokyo (JP)

(72) Inventor: Eiji Hirao, Tokyo (JP)

(73) Assignee: NEC Corporation, Tokyo (JP)

(21) Appl. No.: 13/878,036

(22) PCT Filed: Sep. 12, 2011
(86) PCT No.: PCT/JP2011/071178

§ 371 Date: Apr. 5, 2013

(30) Foreign Application Priority Data
Oct. 6, 2010 (JP) 2010-226394

(51) Int. Cl. G06F 17/27

(52) U.S. Cl. CPC G06F 17/2735
USPC 704/9

(57) ABSTRACT

A request pick-up assisting system includes: a question information registering unit registering a question item and attributes of a questionee; a basic connection word candidate extracting unit referring to information that includes words of the question, and extracting words that coexist with the words of the question; an attribute connection word candidate extracting unit referring to information including words of the question, and information that includes words constituting attributes of the questionee, and extracting, for each attribute, words in which the words of the question and the attributes coexist; an attribute specificity calculating unit calculating an attribute specificity based on dissimilarity between groups of words; an effective attribute extracting unit comparing attribute specificity for each attribute, and extracting a suitable attribute; a connection word extracting unit extracting a connection word about the effective attribute; and an association chart creating unit generating an association chart, by referencing the extracted connection word.

### TECHNICAL FIELD

This invention relates to a request pick-up assisting system, a request pick-up assisting method, and a recording medium which assist in how to conduct a hearing or communication for accurately finding out via questioning needs/issues from the contractee in requirement definition or other similar works in the development of software or a system.

### BACKGROUND ART

In system development or the like, the specifications of a system to be developed are required to reflect various requests of users and the contractee of the system well. Laying down the system specifications therefore involves a request pick-up work such as a hearing for finding out via questioning the needs, issues, images, and other various requests of the contractee.

An example related to a request pick-up method and system is described in Patent Literature 1 (Japanese Unexamined Patent Application Publication (JP-A) No. 2002-157393). In the request pick-up method described in Literature 1, remarks of questionees who have viewed an advertisement expression that is the subject of questioning to a question regarding their impressions of the advertisement expression are first collected on a context basis. The collected remarks are next encoded on a clause basis with the use of a thesaurus in which synonyms are consolidated by sorting predicted remarks by word class, reason, or the like, and a unique code is assigned to each resultant synonym group to systematize the synonym groups. Next, an association chart is created which shows for each remark code an appearance count, a remarker count, and an association count. Operating the system in this manner facilitates the extraction of a questionee's natural association route and context of association.

Another example related to a request pick-up method and system is described in Patent Literature 2 (Japanese Unexamined Patent Application Publication (JP-A) No. 2003-067535). The request pick-up method described in this literature prepares, as a database, basic questions and interruptive questions extracted based on interruption standards in association with attribute information of a questionee and a question subject. When questioning, a reference is made to the database in order to present basic questions suitable for the purpose and interruptive questions determined by the answer pattern, and answers to the presented questions are obtained.

The method thus assists in an interview about current work.

### CITATION LIST

Patent Literature 1: Japanese Unexamined Patent Application Publication (JP-A) No. 2002-157393

Patent Literature 2: Japanese Unexamined Patent Application Publication (JP-A) No. 2003-067535

### DISCLOSURE OF THE INVENTION

### Problems to be Solved by the Invention

Problems in existing request pick-up methods and systems are described. A method that finds out requests via questioning in the manner of Patent Literature 1 assists in grasping a questionee's natural association route and context of association by transforming the questionee's remarks to questions about impressions into an association chart. A problem is that, with no mention on how the remarks themselves are drawn out, obtaining an effective association chart is suspected to be difficult when a questionee does not have a clear image for questions about impressions, for example. This is because most situations under which requests regarding system development are found out via questioning are situations where a questionee answers a question based on past experiences or the like, instead of situations similar to that of Patent Literature 1, where specific information is presented to a questionee right before questioning to find out the questionee's impressions of the information. Under such situations, accurate requests cannot be picked up on unless questions are posed in a manner that ensures that a questionee recalls a scene or the like relevant to the questions well.

Another problem is that a method that finds out requests via questioning in the manner of Patent Literature 2, while being capable of assisting well in questioning about question items for which effective answers have been obtained in the past, cannot deal with conditions for which effective questions are not registered in the database. This method is therefore low in effectiveness in practical use as a request pick-up method. This is because the number of questions to be registered in the database is as many as the number of combinations of attribute information and a question subject, which is enormous, and building a satisfactory database is not easy.

The existing methods are also low in the effect of applying the methods to cases where a system's assistance in finding out requests via questioning is needed more imperatively. The reason is that questioning under conditions where effective answers have been obtained in the past allows the questioner to accumulate the know-how of questioning as his/her own experience. Then there is little need for a system's assistance in finding out requests via questioning. In such cases, users' needs are rather for assistance in conducting appropriate questioning with regard to new question subjects and questionees who have new attributes.

This invention provides a request pick-up assisting system, method, and program which assist a questioner in conducting a hearing by extracting from an arbitrary database a connection word suitable for a question item, based on a question about what the questioner wishes to find out and attributes of a questionee, as additional information which helps the questionee recall a scene or the like relevant to the question well.

This invention also provides a request pick-up assisting system, method, and program with which a script that helps a questionee recall a scene or the like relevant to a question well can be written by creating an association chart that associates connection information extraction with a connection word without using a document database about a business operation that is the subject of a hearing, local dictionary information based on the knowledge of the business operation, or the like, even when the hearing is conducted by a less-experienced questioner or with regard to an unfamiliar field or an unfamiliar questionee.

### Means to Solve the Problem

According to this invention, there is provided a request pick-up assisting system, including: a question information registering unit for registering a question item and attributes of a questionee as texts; a basic connection word candidate extracting unit for referring to information that includes words constituting the question item and that is obtained from a database that collects and accumulates arbitrary text information, and extracting, as basic connection word candidates, a group of words that coexist with the words of the question item; an attribute connection word candidate extracting unit for referring to information that includes words constituting the question item and that is obtained from the database, and information that includes words constituting the attributes of the questionee and that is obtained from the database, and extracting, for each attribute, as attribute connection word candidates, a group of words in which the words of the question item and the words of the attributes coexist; an attribute specificity calculating unit to calculate for each attribute an attribute specificity based on dissimilarity between a group of words that are the basic connection word candidates and groups of words that are the attribute connection word candidates; an effective attribute extracting unit to compare the attribute specificity which is calculated for each attribute, and extracting a suitable attribute; a connection word extracting unit to extract a connection word from attribute connection word candidates about the extracted effective attribute; and an association chart creating unit to generate an association chart which associates words that help the questionee recall a situation relevant to the question item, by referring to the extracted connection word.

### EFFECT OF THE INVENTION

According to this invention, the request pick-up assisting system, method, and program can be provided which assist a questioner in conducting a hearing by extracting from an arbitrary database a connection word suitable for a question item, based on a question about what the questioner wishes to find out and attributes of a questionee, as additional information which helps the questionee recall a scene or the like relevant to the question well.

### BRIEF DESCRIPTION OF THE DRAWING

FIG. 1 is a block diagram illustrating the configuration of an embodiment mode.

FIG. 2 is a flow chart illustrating the operation of the embodiment mode.

FIG. 3 is a Venn diagram illustrating a collective relation of a group of words that are basic connection word candidates and groups of words that are attribute connection word candidates of respective attributes in the embodiment mode.

FIG. 4 is an example of a table of an attribute specificity which is calculated for each attribute keyword in the embodiment mode.

FIG. 5 is a Venn diagram illustrating a collective relation of groups of words that are extracted as connection words from attribute connection word candidates for an effective attribute keyword in the embodiment mode.

FIG. 6 is a list showing a part of groups of words that are connection words extracted from basic connection word candidates and attribute connection word candidates in the embodiment mode.

FIG. 7 is an example of an association chart obtained in the embodiment mode.

FIG. 8 is another example of the association chart obtained in the embodiment mode.

FIG. 9 is a block diagram illustrating a configuration example of a request pick-up assisting system.

FIG. 10 is an explanatory diagram illustrating another configuration example of the request pick-up assisting system.

### BEST MODE FOR EMBODYING THE INVENTION

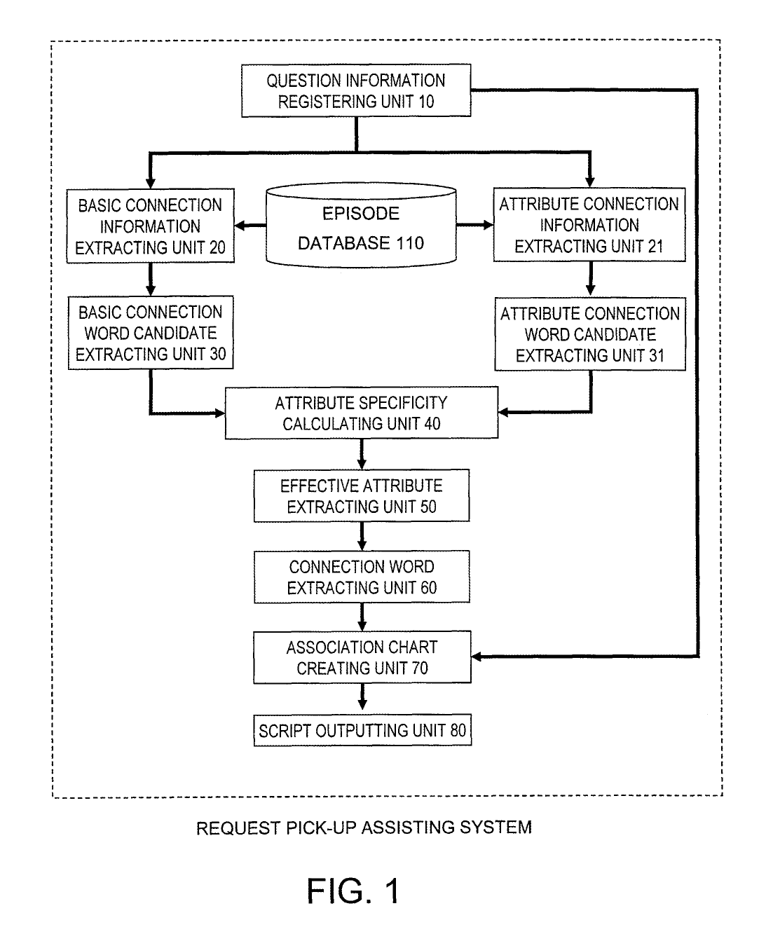

Now, an embodiment mode of this invention is described in detail with reference to the drawings. Referring to FIG. 1, the embodiment mode of this invention basically includes, inside an electronic device or inside a system constituted of a server, an electronic device, and the Internet or a similar information communication network that connects these each other, at least a question information registering unit 10, a basic connection information extracting unit 20, an attribute connection information extracting unit 21, a basic connection word candidate extracting unit 30, an attribute connection word candidate extracting unit 31, an attribute specificity calculating unit 40, an effective attribute extracting unit 50, a connection word extracting unit 60, an association chart creating unit 70, a script outputting unit 80, and an episode database 110.

The question information registering unit 10 receives, as question information, question item information about a question item to which a questioner wishes to find an answer, and a plurality of pieces of questionee attribute information about attributes of a questionee who answers questions, and registers the question item information and the questionee attribute information in the form of question item keywords and attribute keywords, respectively. The question item information may be registered by quoting a keyword in a question sentence that directly asks what the questioner wishes to find out or the like as it is, and directly receiving and registering the input itself as a question item keyword. Instead of this method, a question item keyword may be registered indirectly by receiving an input in the form of a text, and extracting a noun, a verb, and other keywords that have a meaning on their own through the application of morphological analysis to each of sentences that constitute the text. The embodiment mode may be configured so that a large number of question item keywords are obtained by allowing direct registration of a question item keyword and simultaneously conducting an analysis for indirectly extracting a question item keyword. The questionee attribute information is not limited to the assigned work, post, age, gender, and the like of a questionee, and can be any kind of information that indicates a feature of a questionee, such as a keyword about a question in a scaling questionnaire or the like an answer to which deviates greatly from a mean value.

The episode database 110 collects and accumulates, as episode information, text information that contains an arbitrary item and a human attribute and, in response to reference requests from the basic connection information extracting unit 20 and the attribute connection information extracting unit 21, presents requested information. The episode information can be any information group that is a generally accessible document, and does not need to be a document about a business operation that is the subject of the hearing or the like. The episode database 110 is typically a text group or the like of, for example, documents, blog entries, and Q & A sites on the Internet. The episode database 110 may also be a database for managing documents related to past work in a unified manner, or the like. An academic paper database that is not particularly organized or the like may also be added to the episode database 110.

The basic connection information extracting unit 20 refers to the episode information the episode database 110 to extract, as basic connection information, a set of pieces of the episode information in each of which one or more arbitrary types of question item keywords registered as the question information are present. The basic connection information is a sentence, an article, or a site that satisfies a condition that a question item keyword is present within an arbitrarily set range, such as the same sentence, the same article, or the same site. In the case where the episode database 110 holds groups of documents on the Internet, a text information group that is output as a result of a Web search for a keyword about the question item information registered as the question information, or the like, can be used as the basic connection information. To consider a plurality of question item keywords in this case, a Web search conducted by putting an operator AND between the question item keywords can be used. If too many texts are returned by the search, the search may be limited by, for example, excluding documents that are equal to or lower than an arbitrary threshold. The basic connection information extracting unit 20 may register, in association with the extracted basic connection information, information indicating the source of the extracted information.

The attribute connection information extracting unit 21 refers to the episode information in the episode database 110 to extract, as attribute connection information, a set of pieces of the episode information in each of which one or more arbitrary types of question item keywords registered as the question information coexist with one of attribute keywords. The attribute connection information is extracted for each and every attribute keyword about the questionee attribute information. The attribute connection information is a sentence, an article, or a site that satisfies a condition that the question item keyword and the attribute keyword described above coexist within an arbitrarily set range, such as the same sentence, the same article, or the same site. In the case where the episode database 110 holds groups of documents on the Internet, a text information group that is output as a result of an AND Web search for a question item keyword and an attribute keyword that are registered as the question information, or the like, can be used as the attribute connection information. If too many texts are returned by the search, the search may be limited by, for example, excluding documents that are equal to or lower than an arbitrary threshold. The attribute connection information extracting unit 21 may register, in association with the extracted attribute connection information, information indicating the source of the extracted information.

The basic connection word candidate extracting unit 30 extracts, as basic connection word candidates, from the basic connection information, a group of words each of which coexists with one or more question item keywords. One of methods that can be used to extract a basic connection word candidate is to apply morphological analysis to text information of the basic connection information and extract a noun, a verb, and other words that have a meaning on their own. If there are too many words that can be extracted, a limitation such as “equal to or lower than an arbitrary threshold” may be put.

The attribute connection word candidate extracting unit 31 extracts, as attribute connection word candidates, from each piece of the attribute connection information extracted for each attribute keyword, a group of words each of which coexists with one or more question item keywords and the attribute keyword used in the extraction of the piece of the attribute connection information. Attribute connection word candidates are extracted for each and every keyword about the questionee attribute information. One of methods that can be used to extract an attribute connection word candidate is to apply morphological analysis to text information of the attribute connection information and extract a noun, a verb, and other words that have a meaning on their own. If there are too many words that can be extracted, a limitation such as “equal to or lower than an arbitrary threshold” may be put.

The attribute specificity calculating unit 40 calculates, as an attribute specificity, dissimilarity between each word group of attribute connection word candidates extracted for each attribute keyword and a word group of basic connection word candidates. In short, the attribute specificity is extracted for each and every attribute keyword. The attribute specificity may be calculated by a method that utilizes how few duplicates are contained in a word group, for example, the proportion of union sets to intersection sets when a group of words included among basic connection word candidates and groups of words included among attribute connection word candidates for respective attributes are each counted as a set. Alternatively, the attribute specificity may be calculated with the use of a function that has a monotonically decreasing relation with a similarity that is obtained by a vector space method or the like, or a function that has a monotonically decreasing relation with a similarity of a concept that uses a thesaurus or the like. In the case where notational variants that have the same or similar meaning are to be taken into account for each of connection words included among basic connection words and attribute connection words, each connection word may be aggregated before the attribute specificity calculation by counting synonyms in. Synonyms may be counted in with the use of a general thesaurus, or a local dictionary that holds synonyms deduced from word usage examples of various words by applying similarity analysis such as a vector space method or rough set analysis to the episode information of the episode database 110, or to the basic connection information or the attribute connection information.

The effective attribute extracting unit 50 extracts an attribute keyword that has a more suitable specificity by comparing each attribute specificity that has been extracted for each and every attribute keyword against a set evaluation condition.

The evaluation condition is set arbitrarily so as to suit the purpose of the hearing.

Being small in attribute specificity means that the similarity between basic connection word candidates and attribute connection word candidates is high, in other words, that the attribute keyword in question has connection word candidates that change little by taking attributes into consideration, and is effective in assisting a questionee to recall in a hearing that is hardly affected by attribute features of a questionee with regard to the specifics of a question item.

Being large in attribute specificity, on the other hand, means that the similarity between basic connection word candidates and attribute connection word candidates is low, in other words, that the attribute keyword in question has connection word candidates that change greatly by taking attributes into consideration, and is effective in assisting a questionee to recall in a hearing for finding out via questioning information that is unique to an attribute of a questionee.

The evaluation condition that is effective for a hearing that gives importance to results reflecting a feature unique to an attribute is therefore “extract an attribute keyword having the largest attribute specificity” or the like. The evaluation condition that is effective for a hearing that is hardly effected by attribute features of a questionee is “extract an attribute keyword having the smallest attribute specificity” or the like. In the case where the attribute specificity is too large, the association between basic connection word candidates and attribute connection word candidates may be too small, which can cause an adverse effect by making it easy for the topic to veer from the scope of a question item in a hearing. A threshold may therefore be added to the evaluation condition so that “extract an attribute keyword having the largest attribute specificity that is equal to or less than a given threshold”, or a similar pattern, is included in the embodiment mode.

The connection word extracting unit 60 extracts a connection word from attribute connection word candidates that are derived from an attribute keyword extracted by the effective attribute extracting unit 50. The connection word extracting unit 60 may extract a plurality of connection words if there are a plurality of connection words. A connection word may be extracted by a method in which groups of words included among the derived attribute connection word candidates are utilized as they are, a method in which a group of words included among basic connection word candidates is removed from groups of words included among the attribute connection word candidates, thereby reducing a group of words that are have less association with the extracted attribute and extracting the remaining words as connection words, a method in which the extraction is limited to words that are high in appearance frequency, or other methods.

The association chart creating unit 70 creates, for each connection word extracted for each question item to which the questioner wish to find an answer, an association chart which associates the connection word with the question item in a manner that reflects the relation between the question item and the connection word. A suitable association chart is a chart showing, for each question item, connection words that are extracted for the question item in parallel to one another, a graph that puts a question item at the center and links connection words of the question item to one another as nodes, or the like.

The script outputting unit 80 embeds, in a script used in a hearing, the association chart created for each question item to which the questioner wishes to find an answer, and outputs the script so that a person who conducts questioning can consult the association chart in advance or during the hearing. The script can be output in other modes than the simple presentation of the association chart prepared for each question item. In the case where there is a connection word common to the association chart for one question item and the association chart for another question item, the script may be output by displaying a graph that links only the common connection word to the question items and, when a particular question item is selected, presenting the association chart for the selected question item. In the case where the question item information is given in the form of a text, the script may be output by presenting a text in which one of words of each question item in the given text is replaced with a connection word that is associated with a corresponding question item keyword.

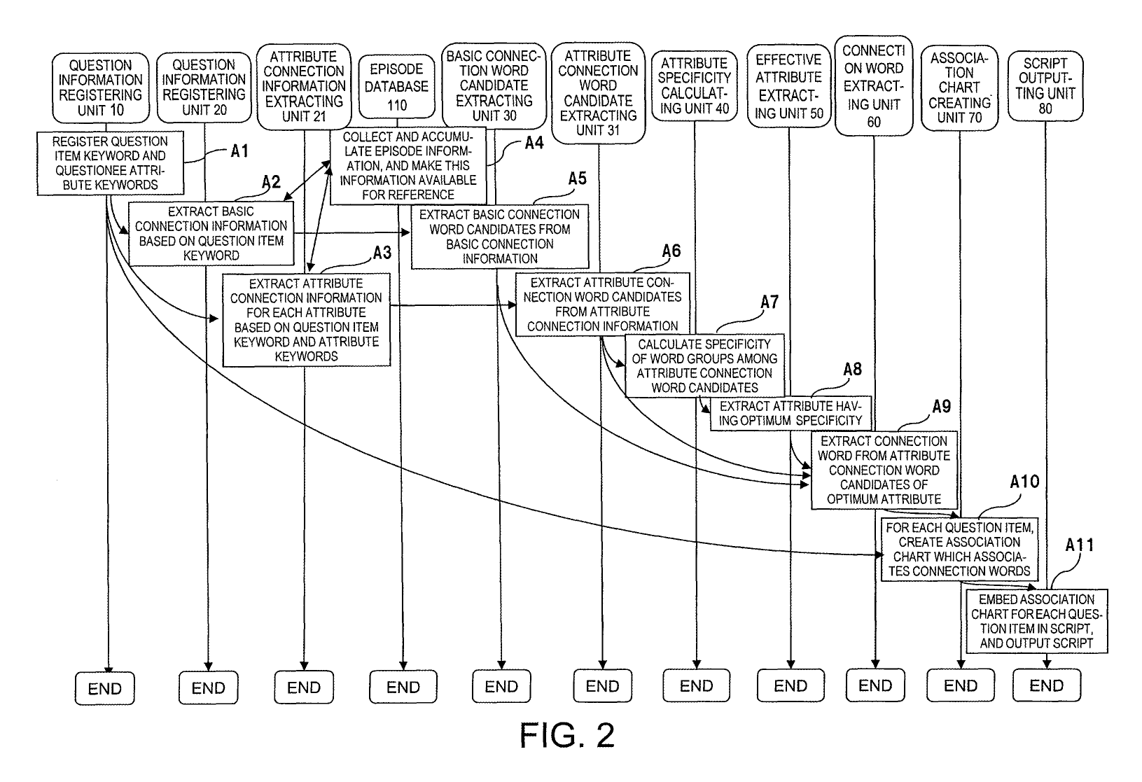

The overall operation of the embodiment mode of this invention is described next with reference to FIGS. 1 and 2.

The question information registering unit 10 receives, as question information, question item information about a question item to which a questioner wishes to find an answer and a plurality of pieces of questionee attribute information about attributes of a questionee who answers questions, and registers the question item information and the questionee attribute information in the form of question item keywords and attribute keywords, respectively (Step A1).

The basic connection information extracting unit 20 refers to episode information in the episode database 110 to extract, as basic connection information, a set of pieces of the episode information in each of which one or more arbitrary types of question item keywords registered as the question information in Step A1 are present (Step A2).

The attribute connection information extracting unit 21 refers to the episode information in the episode database 110 to extract, as attribute connection information, for each attribute keyword, a set of pieces of the episode information in each of which one or more arbitrary types of question item keywords registered as the question information in Step A1 coexist with one of the plurality attribute keywords registered (Step A3).

The episode database 110 collects and accumulates, as episode information, text information that contains an arbitrary item and a human attribute in advance, or after Step A2 and Step A3, and, in response to reference requests from the basic connection information extracting unit 20 and the attribute connection information extracting unit 21, presents requested information (Step A4).

The basic connection word candidate extracting unit 30 extracts, as basic connection word candidates, from the basic connection information extracted in Step A2, a group of words each of which coexists with one or more question item keywords (Step A5).

The attribute connection word candidate extracting unit 31 extracts, as attribute connection word candidates, for each piece of the attribute connection information extracted for each attribute keyword in Step A3, a group of words each of which coexists with one or more question item keywords and the attribute keyword used in the extraction of the piece of the attribute connection information, from the piece of the attribute connection information (Step A6).

The attribute specificity calculating unit 40 calculates, as an attribute specificity, dissimilarity between a word group of basic connection word candidates and each word group of attribute connection word candidates extracted for each and every attribute keyword (Step A7).

The effective attribute extracting unit 50 extracts an attribute keyword that has a more suitable specificity by comparing every attribute specificity that has been extracted for each attribute keyword against an arbitrarily set evaluation condition (Step A8).

The connection word extracting unit 60 extracts a connection word from attribute connection word candidates that are derived from the attribute keyword extracted in Step A8 (Step A9).

The association chart creating unit 70 creates, for each connection word extracted for each question item to which the questioner wishes to find an answer, an association chart which associates the connection word with the question item in a manner that reflects the relation between the question item and the connection word (Step A10).

The script outputting unit 80 embeds, in a script used in a hearing, the association chart created for each question item to which the questioner wishes to find an answer, and outputs the script so that a person who conducts questioning can consult the association chart in advance or during the hearing (Step A11).

The embodiment mode of this invention is described next through an embodiment in detail. This embodiment describes an operation in which, in order to improve an in-house IT system, an association chart Nij for visualizing the relations of connection words which can be connections in a hearing for obtaining information about a question item i from an employee Ej (questionee) is created and embedded in a hearing script Sj to be presented to a questioner B. In this operation, the questioner is provided with a script suited to the question item information and the questionee attribute information, and accomplishing a reliable hearing which does not depend on the whim of the questioner can be set as a goal.

The hearing script Sj is managed by a request pick-up assisting system that is constituted of a hearing assisting system H and an Internet server Z. The hearing assisting system H is run on a PC terminal used by the questioner B, and implements, via an input unit and an output unit, the input of a question sentence Li or a question item keyword Qi about the question item i of which the questioner wishes to obtain information, and attribute keywords Aj of the employee Ej, as well as the presentation of the hearing script Sj. The Internet server Z is connected via a communication network to the PC terminal used by the questioner B in which the hearing assisting system H is installed. The Internet server Z is a device that enables the questioner to conduct a search that uses the question item keyword Qi and the attribute keywords Aj from the hearing assisting system H.

The question information registering unit 10, the basic connection information extracting unit 20, the attribute connection information extracting unit 21, the basic connection word candidate extracting unit 30, the attribute connection word candidate extracting unit 31, the attribute specificity calculating unit 40, the effective attribute extracting unit 50, the connection word extracting unit 60, the association chart creating unit 70, and the script outputting unit 80 are included in the hearing assisting system H. The episode database 110 is included in the Internet server Z.

The hearing assisting system H and the Internet server Z which have these means operate as follows.

The hearing assisting system H receives from the questioner B an input of the question sentence Li about the question item i, and a plurality of attribute keywords Aj. The hearing assisting system H applies morphological analysis to the received question sentence Li to extract, as the question item keywords Qi, a noun, a verb, an adjective, and other keywords that have a meaning on their own. The question item keywords Qi obtained by transforming the question sentence Li and the attribute keywords Aj are then registered.

In the case where the question item i to which an answer is sought in the hearing is “information about the transportation expense reimbursing system”, for example, the question sentence Li can be “dissatisfaction with reimbursement of transportation or other expenses” or the like, and the question item keywords Qi can be “transportation expense”, “reimbursement”, “dissatisfaction”, and the like. Examples of information that may be registered as the attribute keywords Aj of the employee Ej include “female”, which is information about gender, “twenties” which is information about age group, and “sales” which is information about assigned work.

From among the registered arbitrary question item keywords Qi, the hearing assisting system H quotes at least one type of keyword, and uses an arbitrary Web search engine to conduct an AND search and extract the URLs of articles in which the quoted question item keyword Qi is present from a group of documents saved in the Internet server Z. The extracted URLs are sorted in a presentation order based on the past reference frequency performance or the like, and a group of documents at the top 100 URLs is extracted as basic connection information Vi0. In the case where the question item i is “information about the transportation expense reimbursing system”, for example, a Web search is conducted with the use of a search criterion such as “transportation expense * reimbursement * dissatisfaction”.

The hearing assisting system H also quotes at least one type of keyword from among the registered arbitrary question item keywords and one keyword Ajt from among the questionee attribute keywords Aj, and uses an arbitrary Web search engine to conduct an AND search and extract the URLs of articles in which the quoted question item keyword Qi and attribute keyword Ajt coexist, from the group of documents saved in the Internet server Z. The extracted URLs are sorted in a presentation order based on the past reference frequency performance or the like, and a group of documents at the top 100 URLs is extracted as attribute connection information Vijt. The hearing assisting system H executes this extraction processing for every keyword Ajt registered, and the resultant documents constitute an attribute connection information group Vij. In the case where the question item i is “information about the transportation expense reimbursing system” and the keywords Ajt are “female”, “twenties”, and “sales”, for example, a Web search is conducted for each of search criteria, “female * transportation expense * reimbursement * dissatisfaction”, “twenties * transportation expense * reimbursement * dissatisfaction”, and “sales * transportation expense * reimbursement * dissatisfaction”, and respective results of the searches constitute pieces of attribute connection information Vijt. The hearing assisting system H may select at this point a Web search engine (extraction rules, extraction technologies, methods) based on the attribute keywords Ajt. For instance, when the attribute keywords Ajt are “female” and “twenties”, the hearing assisting system H uses a Web search engine that is favored by persons who have those attributes. The method and language used in a search of the episode database may also be varied as the need arises. For instance, in the case of a person whose attributes include “employee stationed in USA” or the like, the language is changed from “Japanese only” to “Japanese+American English” so that English keywords can be extracted in addition to Japanese keywords.

The Internet server Z collects and accumulates a group of various documents that contain an arbitrary item and a human attribute, and provides the function of a Web search engine and other functions as well. In response to a search operation performed on the hearing assisting system H, the Internet server Z extracts and presents documents, articles, or URLs where words used in the accumulated documents match search keywords and search criteria. A Web search engine of an external site may be used instead.

The hearing assisting system H applies morphological analysis to documents included in the basic connection information Vi0 to extract a noun, a verb, an adjective, and other words that have a meaning on their own, and removes the question item keyword Qi from the extracted words to extract, as basic connection word candidates Wci0, a group of words that coexist with the question item keyword Qi. For example, in the case where one of articles obtained as a result of a Web search under a search criterion “transportation expense * reimbursement * dissatisfaction” includes a passage “. . . this system automatically processes reimbursement of transportation expenses and travel expenses without requiring a laborious input work. It must be of much help to sales department workers and other employees who often work outside the office . . . ”, a group of words including “travel expense”, “laborious”, “input work”, “without requiring”, “work outside the office”, and “be of much help” constitutes a group of connection word candidates Wci0.

For each piece of the attribute connection information Vijt, the hearing assisting system

H applies morphological analysis to documents included in the piece of the attribute connection information Vijt to extract a noun, a verb, an adjective, and other words that have a meaning on their own, and removes the question item keyword Qi and the attribute keyword Ajt from the extracted words to extract, as attribute connection word candidates Wcijt, a group of words that coexist with the question item keyword Qi and the questionee attribute keyword Ajt. The attribute connection word candidates Wcijt are extracted for each and every piece of the attribute connection information Vijt.

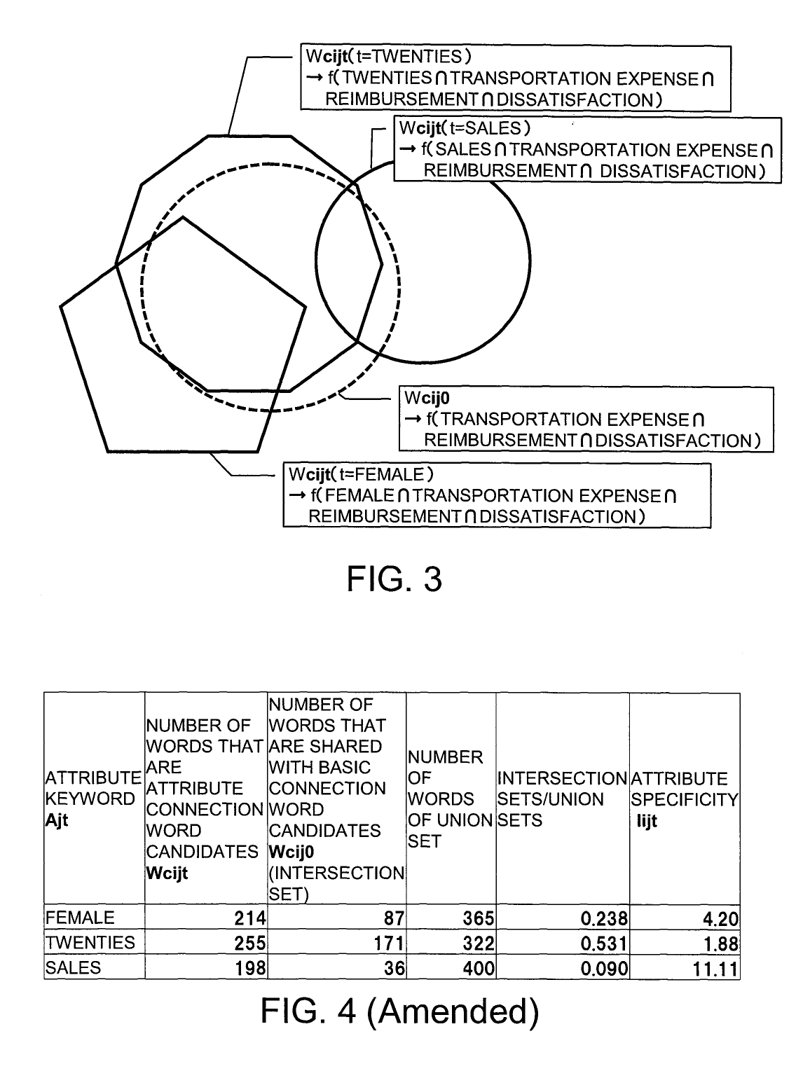

As an example, the hearing assisting system H calculates a duplicate ratio in the form of the proportion of intersection sets to union sets of word groups among the basic connection word candidates Wcij0 and the attribute connection word candidates Wcijt for one attribute keyword Ajt. The hearing assisting system H calculates an inverse number of the duplication ratio as an attribute specificity Iijt of the attribute keyword Ajt. In this example, when the basic connection word candidates Wcij0 are made up of a group of 238 words extracted from the result of a Web search under a search criterion “transportation expense * reimbursement * dissatisfaction”, and the attribute connection word candidates Wcijt are made up of a group of 214 words extracted from the result of a Web search under a search criterion “female * transportation expense * reimbursement * dissatisfaction”, a group of 255 words extracted from the result of a Web search under a search criterion “twenties * transportation expense * reimbursement * dissatisfaction”, and a group of 198 words extracted from the result of a Web search under a search criterion “sales * transportation expense * reimbursement * dissatisfaction” as in the example described above, the collective relation of the word groups is as illustrated in a Venn diagram of FIG. 3, and the attribute specificity Iijk is calculated as shown in a table of FIG. 4.

The hearing assisting system H compares each attribute specificity Iijt calculated for each attribute keyword Ajt against an evaluation condition which is set so as to suit the purpose of the hearing, and thus extracts an effective attribute keyword Aij which has a more suitable specificity. For instance, when the purpose of the hearing is to find out the first-hand experience of the questionee even if it takes time a little, considering information that contains a feature unique to the questionee is given importance, and “extract an attribute keyword having the largest attribute specificity” is therefore set as the evaluation condition. The effective attribute keyword Aij that is extracted when this evaluation condition is applied to the results of FIGS. 3 and 4 is “female”, which has the largest specificity Iijt and is smallest in the amount of overlap with the circle drawn in broken line. On the other hand, when the purpose of the hearing is to find out relatively representative information instead of information unique to the questionee, such as when the number of people available for the hearing is small, not being affected by features of the questionee is given importance, and “extract an attribute keyword having the smallest attribute specificity” is set as the evaluation condition. The effective attribute keyword Aij that is extracted when this evaluation condition is applied to the results of FIGS. 3 and 4 is “twenties”, which has the smallest specificity Iijt and is largest in the amount of overlap with the circle drawn in broken line. In another case where “extract an attribute keyword having the largest attribute specificity that is equal to or less than 10”, or the like, is set as the evaluation condition and applied to the result of FIGS. 3 and 4, “female” which has an attribute specificity larger than 10 is excluded, and the attribute keyword Ajt that has the largest attribute specificity of the remaining attribute keywords, namely, “sales”, is extracted as the effective attribute keyword Aij.

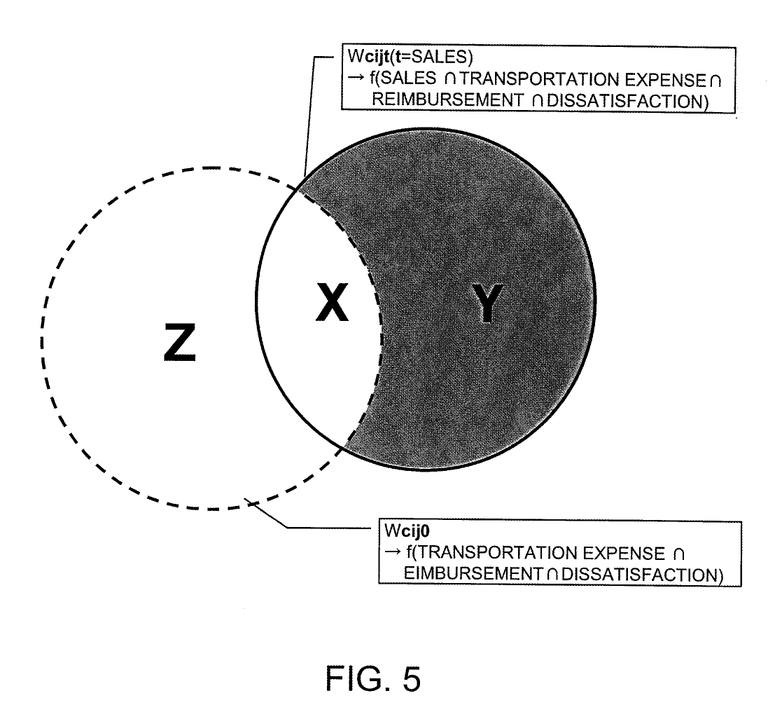

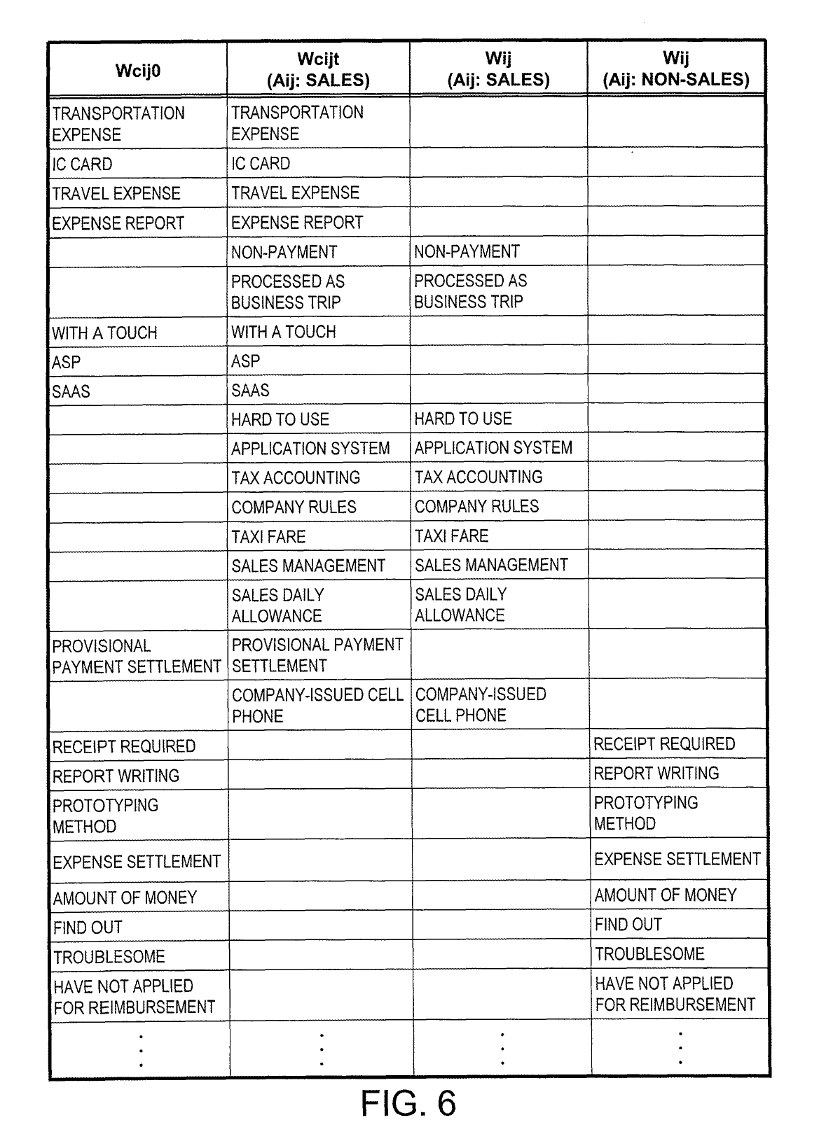

The hearing assisting system H removes a group of words included among the basic connection word candidates Wcij0 from groups of words included among the attribute connection word candidates Wcijt that are derived from the effective attribute keyword Aij to reduce a group of words that have less association with the extracted attribute, and extracts the remaining words as connection words Wij. For example, in the case where “sales” is extracted as the effective attribute keyword Aij from the results of FIGS. 3 and 4 described above, the collective relation of the word groups can be expressed as a Venn diagram of FIG. 5. Out of a solid-line circle of the attribute connection word candidates Wcijt, a group of words contained in an area X which overlaps with a broken-line circle of the basic connection word candidates Wcij0 is removed, and a group of words contained in a solidly painted area Y is extracted as the connection words Wij for “sales”. Alternatively, out of the broken-line circle of the basic connection word candidates Wcij, the group of words contained in the area X which overlaps with the solid-line circle of the attribute connection word candidates Wcijt may be removed, and a group of words contained in an area Z which is enclosed by a broken-line arc and a solid-line arc may be extracted as the connection words Wij for “non-sales”. FIG. 6 is a list showing a part of groups of words that are extracted as the connection words Wij for “sales” and the connection words Wij for “non-sales” from the attribute connection word candidates Wcijt that have been derived with “sales” as the effective attribute keyword Aij and from the basic connection word candidates Wcij0.

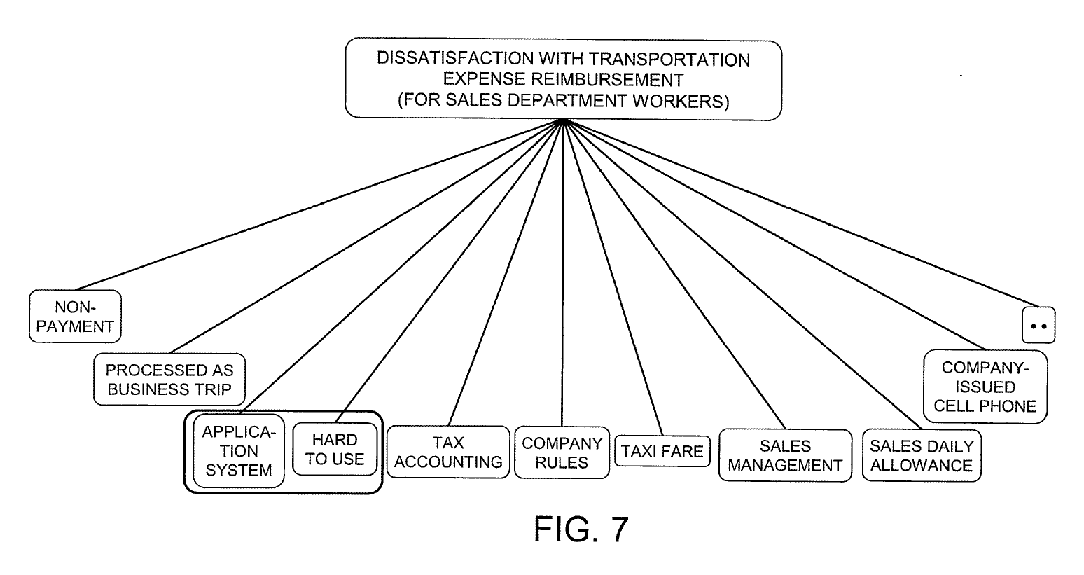

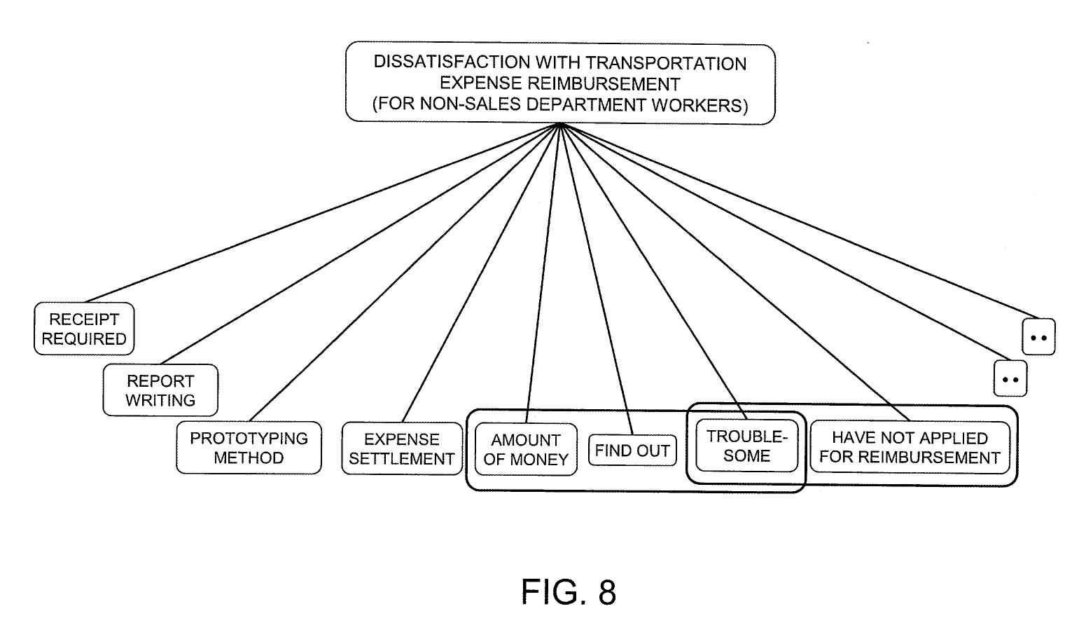

Based on the connection words Wij obtained for each question item i, the hearing assisting system H creates the association chart Nij by creating a graph that puts the question sentence Li of the question item i at the center and links the connection words Wij as nodes to the question sentence Li. Measures for making the association chart Nij easier to read may be taken such as drawing a frame around a group of words that are extracted from the same document or the same text. For example, the association chart Nij based on the connection words Wij for “sales” of FIG. 6 is as illustrated in FIG. 7, and the association chart Nij based on the connection words Wij for “non-sales” of FIG. 6 is as illustrated in FIG. 8. From FIGS. 7 and 8, the system is expected to be capable of presenting connection words that are suited to the respective attributes by, for example, presenting keywords about concrete transportation means such as “taxi fare” and keywords about “dissatisfaction” in system input such as “application system” and “hard to use” to sales department workers who are surmised to go on a business trip or work outside the office often, while presenting keywords about “dissatisfaction” with work prior to input such as “amount of money”, “find out”, “troublesome”, and “have not applied for reimbursement” to non-sales department workers who are surmised to go on a business trip or work outside the office relatively less often.

The hearing assisting system H embeds in the hearing script Sj the association chart Nij created for every question item i to which the questioner wishes to find an answer, and outputs the hearing script Sj to a screen of the PC terminal used by the questioner B so that the questioner B can consult the association chart Nij in the plotting out of questioning prior to the hearing, or as a supplementary material during the hearing. The hearing script Sj may be output by simply presenting the association chart Nij for each question item i. In the case where there is a common connection word Mjq which is common to the association chart Nij for one question item and the association chart Nij for another question item, the hearing script Sj may be output by displaying a graph that links only the common connection word Mjq to the question sentences Li of the question items i and, when a particular question item i is selected, presenting the association chart Nij for the selected question item i.

Effects of the embodiment mode of this invention are described next. In this embodiment mode, a questioner can question a questionee with the knowledge of connection information that the questionee side has about a question item that the questioner wishes to ask. The questioner can therefore pose a question in a manner that helps the questionee recall a scene or the like relevant to the question well even when the questioner is less experienced or when the hearing is conducted with regard to an unfamiliar field or an unfamiliar questionee. In short, a hearing that is most effective for the current case is accomplished. In addition, the questioner can change the topic while keeping in mind a connection word that is common to question items, and can accordingly conduct a questioning without a hitch that gives the questionee a feeling of strangeness. A more effective hearing is thus accomplished.

By selecting a Web search engine based on the attribute keyword, an association chart can be created from keywords that are close to the viewpoint of the questionee, and a questioning can thus be conducted without a hitch that gives the questionee a feeling of strangeness. The type of the episode database may also be varied depending on the attribute keyword, which leads to a more effective and thorough hearing.

Effects of the request pick-up assisting system, method, and program are described next.

One aspect of the effects is that the information processing enables a questioner to pose a question in a manner that helps a questionee recall a scene or the like relevant to the question well. The reason is that connection words based on attributes of the questionee which are expected to contribute to the efficient progress of a hearing are extracted with respect to a question item that the questioner wishes to ask, and then made available for consultation by the questioner prior to and during the hearing in order to assist in the hearing. This effect is obtained by configuring the system so as to include: receiving the registration of question item keywords about what a questioner wishes to find out and attribute keywords about attributes of a questionee; extracting, for each attribute keyword, basic connection information in which a question item keyword is present and attribute connection information in which at least one question item keyword coexists with at least one attribute keyword, from an episode database which collects and accumulates, as episode information, text information containing an arbitrary item and a human attribute; calculating an attribute specificity based on dissimilarity of each piece of attribute connection information to the basic connection information; creating an association chart which associates the connection item with a connection word included in attribute connection information that is derived from an attribute keyword extracted by comparing each attribute specificity; embedding the association chart in a script that is used in a hearing; and outputting the script so that the person who conducts questioning can consult the association chart prior to and during the hearing.

Another aspect of the effects is that a script that helps a questionee recall a scene or the like relevant to a question well can be written even for a hearing that involves a less-experienced questioner, an unfamiliar field, and an unfamiliar questionee. This is because the system creates an association chart that associates connection information extraction and a connection word with the use of only a generally accessible document database or general dictionary information, thereby making it possible to create an association chart that associates connection words and embed the association chart in a script without requiring a document database about a business operation that is the subject of a hearing or a local dictionary based on the knowledge of the business operation.

As has been described, this invention can assist a questioner in conducting a hearing of a questionee by obtaining connection words suitable for a question item from an arbitrary database, based on a question about what the questioner wishes to find out and attributes of the questionee, as useful additional information which helps the questionee recall a scene or the like relevant to the question well.

The concrete configuration of this invention is not limited to the embodiment mode and embodiment described above, and modifications can be made without departing from the spirit of this invention.

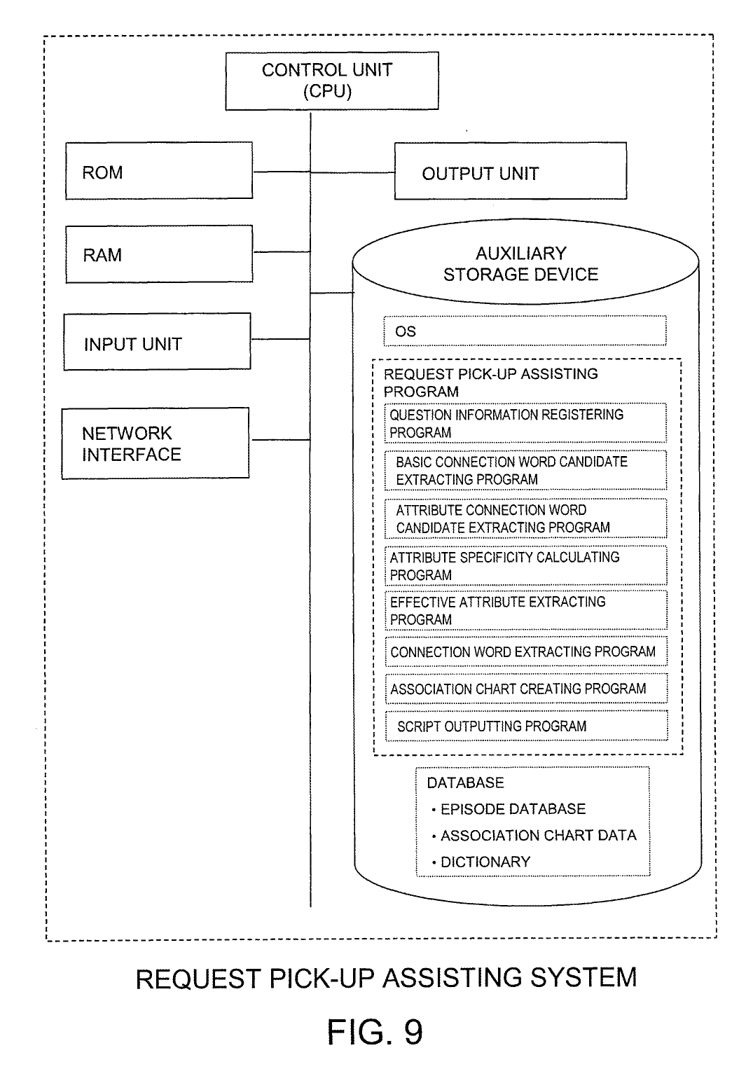

For instance, this invention includes a program for causing a CPU(s) of one or a plurality of computers to operate as a request pick-up assisting system, and a recording medium having the program recorded thereon as well. The program is configured as illustrated in FIG. 9, and is deployed on a memory to cause the CPU to operate as all or some of question information registering means, an episode database, basic connection information extracting means, attribute connection information extracting means, basic connection word candidate extracting means, attribute connection word candidate extracting means, attribute specificity calculating means, effective attribute extracting means, connection word extracting means, association chart creating means, and script outputting means. As a result, an association chart is automatically generated from a question item and questionee attributes which are input via an input unit of the computer such as a keyboard, and from an arbitrary database, and is presented to the questioner in a recognizable manner. The components of the request pick-up assisting system are implemented by hardware or by a combination of hardware and software.

The program may be recorded in a recording medium to be distributed. The program recorded in the recording medium is read onto a RAM of an information processing device via a cable connection, a wireless connection, or the recording medium itself, and runs a control unit or the like. Examples of the recording medium include an optical disc, a magnetic disk, a semiconductor memory device, and a hard disk.

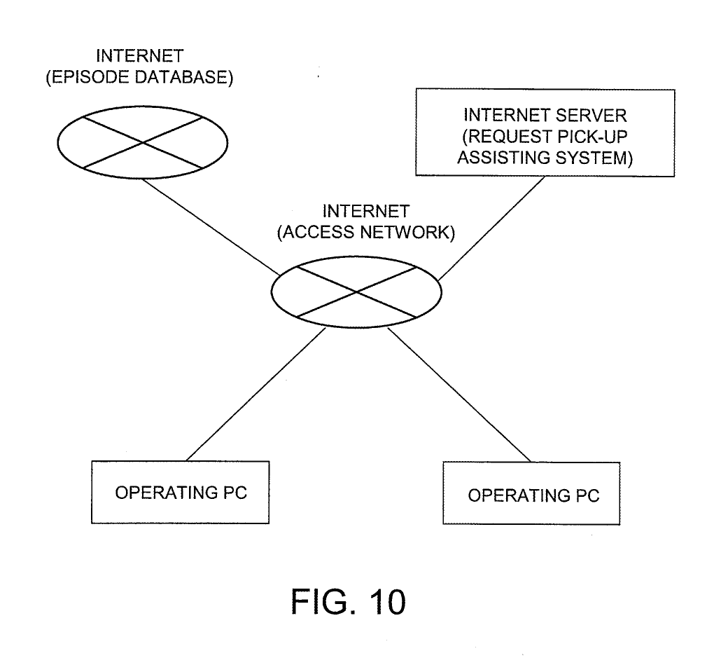

As illustrated in FIG. 10 as an example, the program may be recorded and held in a recording medium on a server in an operable manner so that processing involved in request-pickup assisting is performed with the use of a CPU and a memory unit of the server.

A part of or the entirety of the embodiment mode described above can also be described as follows. The following notes, however, do not limit this invention in any way.

### [Note 1]

A request pick-up assisting system, including:
a question information registering unit for registering a question item and attributes of a questionee as texts;
a basic connection word candidate extracting unit for referring to information that includes words constituting the question item and that is obtained from a database that collects and accumulates arbitrary text information, and extracting, as basic connection word candidates, a group of words that coexist with the words of the question item;
an attribute connection word candidate extracting unit for referring to information that includes words constituting the question item and that is obtained from the database, and information that includes words constituting the attributes of the questionee and that is obtained from the database, and extracting, for each attribute, as attribute connection word candidates, a group of words in which the words of the question item and the words of the attributes coexist;
an attribute specificity calculating unit for calculating, for each attribute, an attribute specificity based on dissimilarity between a group of words that are the basic connection word candidates and groups of words that are the attribute connection word candidates;
an effective attribute extracting unit for comparing the attribute specificity which is calculated for each attribute, and extracting a suitable attribute;
a connection word extracting unit for extracting a connection word from attribute connection word candidates about the extracted effective attribute; and
an association chart creating unit for referring to the extracted connection word and generating an association chart which associates words that help the questionee recall a situation relevant to the question item.

### [Note 2]

A request pick-up assisting system, including:
a question information registering unit for receiving, as question information, question item information about a question item for which a questioner wishes to find an answer, and a plurality of pieces of questionee attribute information about attributes of a questionee who answers questions, and registering the question item information in a form of question item keywords and the plurality of pieces of questionee attribute information in a form of attribute keywords;
an episode database for collecting and accumulating, as episode information, text information which contains an arbitrary item and a human attribute, and presenting information in response to reference requests;
a basic connection information extracting unit for extracting, by referring to the episode information in the episode database, as basic connection information, a set of pieces of the episode information in each of which one or more arbitrary types of question item keywords registered as question information are present;
an attribute connection information extracting unit for extracting, by referring to the episode information in the episode database, for each attribute, as attribute connection information, a set of pieces of the episode information in each of which one or more arbitrary types of question item keywords registered as question information and one or more arbitrary types of attribute keywords registered as question information are present;
a basic connection word candidate extracting unit for extracting, from the extracted basic connection information, as basic connection word candidates, a group of words that coexist with one or more question item keywords;
an attribute connection word candidate extracting unit for extracting, from each piece of the extracted attribute connection information, as attribute connection word candidates, a group of words that coexist with one or more question item keyword and the attribute keyword that has been used to extract the piece of attribute connection information;
an attribute specificity calculating unit for calculating an attribute specificity based on dissimilarity between a group of words that are the basic connection word candidates and groups of words that are the attribute connection word candidates;
an effective attribute extracting unit for comparing each attribute specificity calculated for each attribute against an arbitrarily set evaluation condition, and extracting an attribute keyword that has a more suitable specificity;
a connection word extracting unit for extracting a connection word from attribute connection word candidates that are derived from the attribute keyword extracted by the effective attribute extracting unit;
an association chart creating unit for creating, for each connection word extracted for each question item to which an answer is sought, an association chart which associates the connection word and the question item in a manner that reflects a relation between the connection word and the question item; and
a script outputting unit for embedding, in a script to be used in a hearing, the association chart created for each question item to which an answer is sought, and outputting the script so as to enable a questioner who conducts questioning to consult the association chart prior to and during the hearing.

### [Note 3]

A request pick-up assisting system as described in the above-mentioned Note, in which the connection word extracting unit removes a group of words that are included among the basic connection word candidates from groups of words that are included among the attribute connection word candidates, thereby reducing a group of words that have less association with the extracted attribute and extracting remaining words as connection words.

### [Note 4]

A request pick-up assisting system as described in the above-mentioned Notes, in which the attribute specificity calculating unit treats each of a group of words included among the basic connection word candidates and groups of words included among the attribute connection word candidates for respective attributes as a set, and the attribute specificity calculating unit calculates the attribute specificity based on a proportion of union sets to intersection sets, with how few duplicates are contained in two opposed word groups as an index of the attribute specificity.

### [Note 5]

A request pick-up assisting system as described in the above-mentioned Notes,
in which the database or the episode database is a group of texts on the Internet,
in which the basic connection word candidate extracting unit extracts, as basic connection information, a text information group that is output as a result of a Web search using a keyword about question item information registered as the question information, or an AND Web search using a plurality of question item keywords, and
in which the attribute connection word candidate extracting unit extracts, as attribute connection information, a text information group that is output as a result of an AND Web search using the question item keywords registered as the question information and the attributes keywords registered as the question information.

### [Note 6]

A request pick-up assisting system as described in the above-mentioned Notes, in which the question information registering unit receives question information in a form of a text, applies morphological analysis to each sentence that constitutes the text to extract a group of words that have a meaning on their own, and registers the extracted group of words as question items or questionee attributes.

### [Note 7]

A request pick-up assisting system as described in the above-mentioned Notes, in which, when there is a connection word common to the association chart for one question item and the association chart for another question item, the script outputting unit displays a graph that links only the question items and the common connection word and, when a particular question item is selected, presents the association chart for the selected particular question item.

### [Note 8]

A request pick-up assisting system as described in the above-mentioned Notes, in which, when the question item information is given in a form of a text, the script outputting unit presents a text in which one of words of each question item in the given text is replaced with a connection word that is associated with a word of a corresponding question item.

### [Note 9]

A request pick-up assisting method, including:
registering a question item and attributes of a questionee as texts;
referring to information that includes words constituting the question item and that is obtained from a database that collects and accumulates arbitrary text information, and extracting, as basic connection word candidates, a group of words that coexist with the words of the question item;
referring to information that includes words constituting the question item and that is obtained from the database, and information that includes words constituting the attributes of the questionee and that is obtained from the database, and extracting, for each attribute, as attribute connection word candidates, a group of words in which the words of the question item and the words of the attributes coexist;
calculating, for each attribute, an attribute specificity based on dissimilarity between a group of words that are the basic connection word candidates and groups of words that are the attribute connection word candidates;
comparing the attribute specificity which is calculated for each attribute, and extracting a suitable attribute;
extracting a connection word from attribute connection word candidates about the extracted effective attribute;
referring to the extracted connection word and generating an association chart which associates words that help the questionee recall a situation relevant to the question item; and
presenting the generated association chart to a questioner in a recognizable manner.

### [Note 10]

A request pick-up assisting method, including:
receiving, as question information, question item information about a question item for which a questioner wishes to find an answer, and a plurality of pieces of questionee attribute information about attributes of a questionee who answers questions, and registering the question item information in a form of question item keywords and the plurality of pieces of questionee attribute information in a form of attribute keywords;
extracting, by referring to episode information in an episode database for collecting and accumulating, as the episode information, text information which contains an arbitrary item and a human attribute, and for presenting information in response to reference requests, as basic connection information, a set of pieces of the episode information in each of which one or more arbitrary types of question item keywords registered as question information are present;
extracting, by referring to the episode information in the episode database, for each attribute, as attribute connection information, a set of pieces of the episode information in each of which one or more arbitrary types of question item keywords registered as question information and one or more arbitrary types of attribute keywords registered as question information are present;
extracting, from the extracted basic connection information, as basic connection word candidates, a group of words that coexist with one or more question item keywords;
extracting, from each piece of the extracted attribute connection information, as attribute connection word candidates, a group of words that coexist with one or more question item keyword and the attribute keyword that has been used to extract the piece of attribute connection information;
calculating an attribute specificity based on dissimilarity between a group of words that are the basic connection word candidates and groups of words that are the attribute connection word candidates;
comparing each attribute specificity calculated for each attribute against an arbitrarily set evaluation condition, and extracting an attribute keyword that has a more suitable specificity;
extracting a connection word from attribute connection word candidates that are derived from the extracted attribute keyword;
creating, for each connection word extracted for each question item to which an answer is sought, an association chart which associates the connection word and the question item in a manner that reflects a relation between the connection word and the question item; and
embedding, in a script to be used in a hearing, the association chart created for each question item to which an answer is sought, and outputting the script so as to enable a questioner who conducts questioning to consult the association chart prior to and during the hearing.

### [Note 11]

A request pick-up assisting method as described in the above-mentioned Note, further including removing a group of words that are included among the basic connection word candidates from groups of words that are included among the attribute connection word candidates, thereby reducing a group of words that have less association with the extracted attribute and extracting remaining words as connection words.

### [Note 12]

A request pick-up assisting method as described in the above-mentioned Notes, further including treating each of a group of words included among the basic connection word candidates and groups of words included among the attribute connection word candidates for respective attributes as a set, and calculating the attribute specificity based on a proportion of union sets to intersection sets, with how few duplicates are contained in two opposed word groups as an index of the attribute specificity.

### [Note 13]

A request pick-up assisting method as described in the above-mentioned Note,
in which the database or the episode database is a group of texts on the Internet,
in which the extracting of the basic connection word candidates includes extracting, as basic connection information, a text information group that is output as a result of a Web search using a keyword about question item information registered as the question information, or an AND Web search using a plurality of question item keywords, and
in which the extracting of the attribute connection word candidates includes extracting, as attribute connection information, a text information group that is output as a result of an AND Web search using the question item keywords registered as the question information and the attributes keywords registered as the question information.

### [Note 14]

A request pick-up assisting method as described in the above-mentioned Notes, further including receiving question information in a form of a text, applying morphological analysis to each sentence that constitutes the text to extract a group of words that have a meaning on their own, and registering the extracted group of words as question items or questionee attributes.

### [Note 15]

A request pick-up assisting method as described in the above-mentioned Notes, further including displaying, when there is a connection word common to the association chart for one question item and the association chart for another question item, a graph that links only the question items and the common connection word and, when a particular question item is selected, presenting the association chart for the selected particular question item.

### [Note 16]

A request pick-up assisting method as described in the above-mentioned Notes, further including presenting, when the question item information is given in a form of a text, a text in which one of words of each question item in the given text is replaced with a connection word that is associated with a word of a corresponding question item.

### [Note 17]

A request pick-up assisting program for causing a control unit of an information processing device to function as:
question information registering means for registering a question item and attributes of a questionee as texts;
basic connection word candidate extracting means for referring to information that includes words constituting the question item and that is obtained from a database that collects and accumulates arbitrary text information, and extracting, as basic connection word candidates, a group of words that coexist with the words of the question item;
attribute connection word candidate extracting means for referring to information that includes words constituting the question item and that is obtained from the database, and information that includes words constituting the attributes of the questionee and that is obtained from the database, and extracting, for each attribute, as attribute connection word candidates, a group of words in which the words of the question item and the words of the attributes coexist;
attribute specificity calculating means for calculating, for each attribute, an attribute specificity based on dissimilarity between a group of words that are the basic connection word candidates and groups of words that are the attribute connection word candidates;
effective attribute extracting means for comparing the attribute specificity which is calculated for each attribute, and extracting a suitable attribute;
connection word extracting means for extracting a connection word from attribute connection word candidates about the extracted effective attribute;
association chart creating means for referring to the extracted connection word and generating an association chart which associates words that help the questionee recall a situation relevant to the question item; and
outputting means for presenting the generated association chart to a questioner in a recognizable manner.

### [Note 18]

A request pick-up assisting program for causing a control unit of an information processing device to function as:
question information registering means for receiving, as question information, question item information about a question item for which a questioner wishes to find an answer, and a plurality of pieces of questionee attribute information about attributes of a questionee who answers questions, and registering the question item information in a form of question item keywords and the plurality of pieces of questionee attribute information in a form of attribute keywords;
an episode database for collecting and accumulating, as episode information, text information which contains an arbitrary item and a human attribute, and presenting information in response to reference requests;
basic connection information extracting means for extracting, by referring to the episode information in the episode database, as basic connection information, a set of pieces of the episode information in each of which one or more arbitrary types of question item keywords registered as question information are present;
attribute connection information extracting means for extracting, by referring to the episode information in the episode database, for each attribute, as attribute connection information, a set of pieces of the episode information in each of which one or more arbitrary types of question item keywords registered as question information and one or more arbitrary types of attribute keywords registered as question information are present;
basic connection word candidate extracting means for extracting, from the extracted basic connection information, as basic connection word candidates, a group of words that coexist with one or more question item keywords;
attribute connection word candidate extracting means for extracting, from each piece of the extracted attribute connection information, as attribute connection word candidates, a group of words that coexist with one or more question item keyword and the attribute keyword that has been used to extract the piece of attribute connection information;
attribute specificity calculating means for calculating an attribute specificity based on dissimilarity between a group of words that are the basic connection word candidates and groups of words that are the attribute connection word candidates;
effective attribute extracting means for comparing each attribute specificity calculated for each attribute against an arbitrarily set evaluation condition, and extracting an attribute keyword that has a more suitable specificity;
connection word extracting means for extracting a connection word from attribute connection word candidates that are derived from the attribute keyword extracted by the effective attribute extracting means;
association chart creating means for creating, for each connection word extracted for each question item to which an answer is sought, an association chart which associates the connection word and the question item in a manner that reflects a relation between the connection word and the question item; and
script outputting means for embedding, in a script to be used in a hearing, the association chart created for each question item to which an answer is sought, and outputting the script so as to enable a questioner who conducts questioning to consult the association chart prior to and during the hearing.

### [Note 19]

A request pick-up assisting program as described in the above-mentioned Note, in which the connection word extracting means removes a group of words that are included among the basic connection word candidates from groups of words that are included among the attribute connection word candidates, thereby reducing a group of words that have less association with the extracted attribute and extracting remaining words as connection words.

### [Note 20]

A request pick-up assisting program as described in the above-mentioned Note, in which the attribute specificity calculating means treats each of a group of words included among the basic connection word candidates and groups of words included among the attribute connection word candidates for respective attributes as a set, and calculates the attribute specificity based on a proportion of union sets to intersection sets, with how few duplicates are contained in two opposed word groups as an index of the attribute specificity.

### [Note 21]

A request pick-up assisting program as described in the above-mentioned Note,
in which the database or the episode database is a group of texts on the Internet,
in which the basic connection word candidate extracting means extracts, as basic connection information, a text information group that is output as a result of a Web search using a keyword about question item information registered as the question information, or an AND Web search using a plurality of question item keywords, and
in which the attribute connection word candidate extracting means extracts, as attribute connection information, a text information group that is output as a result of an AND Web search using the question item keywords registered as the question information and the attributes keywords registered as the question information.

### [Note 22]

A request pick-up assisting program as described in the above-mentioned Notes, in which the question information registering means receives question information in a form of a text, applies morphological analysis to each sentence that constitutes the text to extract a group of words that have a meaning on their own, and registers the extracted group of words as question items or questionee attributes.

### [Note 23]

A request pick-up assisting program as described in the above-mentioned Notes, in which, when there is a connection word common to the association chart for one question item and the association chart for another question item, the script outputting means displays a graph that links only the question items and the common connection word and, when a particular question item is selected, presents the association chart for the selected particular question item.

### [Note 24]

A request pick-up assisting program as described in the above-mentioned Notes, in which, when the question item information is given in a form of a text, the script outputting means presents a text in which one of words of each question item in the given text is replaced with a connection word that is associated with a word of a corresponding question item.

### [Note 25]

A recording medium having recorded thereon a request pick-up assisting program for causing a control unit of an information processing device to function as:
question information registering means for registering a question item and attributes of a questionee as texts;
basic connection word candidate extracting means for referring to information that includes words constituting the question item and that is obtained from a database that collects and accumulates arbitrary text information, and extracting, as basic connection word candidates, a group of words that coexist with the words of the question item;
attribute connection word candidate extracting means for referring to information that includes words constituting the question item and that is obtained from the database, and information that includes words constituting the attributes of the questionee and that is obtained from the database, and extracting, for each attribute, as attribute connection word candidates, a group of words in which the words of the question item and the words of the attributes coexist;
attribute specificity calculating means for calculating, for each attribute, an attribute specificity based on dissimilarity between a group of words that are the basic connection word candidates and groups of words that are the attribute connection word candidates;
effective attribute extracting means for comparing the attribute specificity which is calculated for each attribute, and extracting a suitable attribute;
connection word extracting means for extracting a connection word from attribute connection word candidates about the extracted effective attribute;
association chart creating means for referring to the extracted connection word and generating an association chart which associates words that help the questionee recall a situation relevant to the question item; and
outputting means for presenting the generated association chart to a questioner in a recognizable manner.

This invention assists in a hearing for accurately finding out via questioning needs/issues from the contractee in requirement definition or other similar works in the development of software or a system. This invention is thus applicable to uses related to efficiency enhancement of system development, such as the reduction of rework and improvement in customer satisfaction.

This application claims priority on the basis of Japanese Patent Application No. 2010-226394 filed on Oct. 6, 2010, and hereby incorporates by reference the disclosure thereof in its entirety.

### REFERENCE SIGNS LIST

10 question information registering unit

20 basic connection information extracting unit

21 attribute connection information extracting unit

30 basic connection word candidate extracting unit

31 attribute connection word candidate extracting unit

40 attribute specificity calculating unit

50 effective attribute extracting unit

60 connection word extracting unit

70 association chart creating unit

80 script outputting unit

110 episode database

1. A request pick-up assisting system, comprising:
a question information registering unit for registering a question item and attributes of a questionee as question information;
a basic connection word candidate extracting unit for referring to information that includes words constituting the question item and that is obtained from a database that collects and accumulates arbitrary text information, and to extract as basic connection word candidates a group of words that coexist with the words of the question item;
an attribute connection word candidate extracting unit for referring to information that includes words constituting the question item and that is obtained from the database, and information that includes words constituting the attributes of the questionee and that is obtained from the database, and to extract for each attribute, as attribute connection word candidates a group of words in which the words of the question item and the words of the attributes coexist;
an attribute specificity calculating unit calculate for each attribute an attribute specificity, based on dissimilarity between a group of words that are the basic connection word candidates and groups of words that are the attribute connection word candidates;
an effective attribute extracting unit to compare the attribute specificity which is calculated for each attribute, and to extract a suitable attribute;
a connection word extracting unit to extract a connection word from attribute connection word candidates about the extracted effective attribute; and
an association chart creating unit to generate an association chart which associates words that help the questionee recall a situation relevant to the question item, by referring to the extracted connection word.

2. A request pick-up assisting system according to claim 1, further comprising:
an episode database for collecting and accumulating text information as episode information, which contains an arbitrary item and a human attribute, and presenting information in response to reference requests;
a basic connection information extracting unit to extract by referring to the episode information in the episode database as basic connection information, a set of pieces of the episode information in each of which one or more arbitrary types of question item keywords registered as question information are present;
an attribute connection information extracting unit to extract by referring to the episode information in the episode database for each attribute as attribute connection information, a set of pieces of the episode information in each of which one or more arbitrary types of question item keywords registered as question information and one or more arbitrary types of attribute keywords registered as question information are present; and
a script outputting unit to embed in a script to be used in a hearing the association chart created for each question item to which an answer is sought, and to output the script so as to enable a questioner who conducts questioning to consult the association chart prior to and during the hearing,
wherein the question information registering unit receives, as question information, question item information about a question item for which the questioner wishes to find an answer, and a plurality of pieces of questionee attribute information about attributes of a questionee who answers questions, and registers the question item information in a form of question item keywords and the plurality of pieces of questionee attribute information in a form of attribute keywords,
wherein the basic connection word candidate extracting unit extracts, from the extracted basic connection information, as basic connection word candidates, a group of words that coexist with one or more question item keywords,
wherein the attribute connection word candidate extracting unit extracts, from each piece of the extracted attribute connection information, as attribute connection word candidates, a group of words that coexist with one or more question item keyword and the attribute keyword that has been used to extract the piece of attribute connection information,
wherein the attribute specificity calculating unit calculates an attribute specificity based on dissimilarity between a group of words that are basic connection word candidates and groups of words that are attribute connection word candidates,
wherein the effective attribute extracting unit compares each attribute specificity calculated for each attribute against an arbitrarily set evaluation condition, and extracts an attribute keyword that has a more suitable specificity,
wherein the connection word extracting unit extracts a connection word from attribute connection word candidates that are derived from the attribute keyword extracted by the effective attribute extracting unit, and wherein the association chart creating unit creates, for each connection word extracted for each question item to which an answer is sought, an association chart which associates the connection word and the question item in a manner that reflects a relation between the connection word and the question item.

3. A request pick-up assisting system according to claim 1, wherein the connection word extracting unit removes a group of words that are included among the basic connection word candidates from groups of words that are included among the attribute connection word candidates, thereby reducing a group of words that have less association with the extracted attribute and extracting remaining words as connection words.

4. A request pick-up assisting system according to claim 1, wherein the attribute specificity calculating unit treats each of a group of words included among the basic connection word candidates and groups of words included among the attribute connection word candidates for respective attributes as a set, and the attribute specificity calculating unit calculates the attribute specificity based on a proportion of union sets to intersection sets, with how few duplicates are contained in two opposed word groups as an index of the attribute specificity.

5. A request pick-up assisting system according to claim 1,
wherein the database comprises a group of texts on the Internet,
wherein the basic connection word candidate extracting unit extracts, as basic connection information, a text information group that is output as a result of a Web search using a keyword about question item information registered as the question information, or an AND Web search using a plurality of question item keywords, and
wherein the attribute connection word candidate extracting unit extracts, as attribute connection information, a text information group that is output as a result of an AND Web search using the question item keywords registered as the question information and the attributes keywords registered as the question information.

6. A request pick-up assisting system according to claim 1, wherein the question information registering unit receives question information in a form of a text, applies morphological analysis to each sentence that constitutes the text to extract a group of words that have a meaning on their own, and registers the extracted group of words as question items or questionee attributes.

7. A request pick-up assisting system according to claim 2, wherein, when there is a connection word common to the association chart for one question item and the association chart for another question item, the script outputting unit displays a graph that links only the question items and the common connection word and, when a particular question item is selected, presents the association chart for the selected particular question item.

8. A request pick-up assisting system according to claim 2, wherein, when the question item information is given in a form of a text, the script outputting unit presents a text in which one of words of each question item in the given text is replaced with a connection word that is associated with a word of a corresponding question item.

9. A request pick-up assisting system according to claim 1, wherein the basic connection word candidate extracting unit and the attribute connection word candidate extracting unit obtain information by varying a type of the database depending on the registered questionee attribute.

10. A request pick-up assisting system according to claim 1, wherein the basic connection word candidate extracting unit and the attribute connection word candidate extracting unit obtain information by varying how the database is searched depending on the registered questionee attribute.

11. A request pick-up assisting method, comprising:
registering a question item and attributes of a questionee as question information;
referring to information that includes words constituting the question item and that is obtained from a database that collects and accumulates arbitrary text information, and extracting, as basic connection word candidates, a group of words that coexist with the words of the question item;
referring to information that includes words constituting the question item and that is obtained from the database, and information that includes words constituting the attributes of the questionee and that is obtained from the database, and extracting, for each attribute, as attribute connection word candidates, a group of words in which the words of the question item and the words of the attributes coexist;
calculating, for each attribute, an attribute specificity based on dissimilarity between a group of words that are the basic connection word candidates and groups of words that are the attribute connection word candidates;
comparing the attribute specificity which is calculated for each attribute, and extracting a suitable attribute;
extracting a connection word from attribute connection word candidates about the extracted effective attribute;
referring to the extracted connection word and generating an association chart which associates words that help the questionee recall a situation relevant to the question item; and
presenting the generated association chart to a questioner in a recognizable manner.

12. A request pick-up assisting method according to claim 11, further comprising removing a group of words that are included among the basic connection word candidates from groups of words that are included among the attribute connection word candidates, thereby reducing a group of words that have less association with the extracted attribute and extracting remaining words as connection words.

13. A request pick-up assisting method according to claim 11,
wherein the database comprises a group of texts on the Internet,
wherein the extracting of the basic connection word candidates comprises extracting, as basic connection information, a text information group that is output as a result of a Web search using a keyword about question item information registered as the question information, or an AND Web search using a plurality of question item keywords, and
wherein the extracting of the attribute connection word candidates comprises extracting, as attribute connection information, a text information group that is output as a result of an AND Web search using the question item keywords registered as the question information and the attributes keywords registered as the question information.

14. A request pick-up assisting method according to claim 11, further comprising displaying, when there is a connection word common to the association chart for one question item and the association chart for another question item, a graph that links only the question items and the common connection word and, when a particular question item is selected, presenting the association chart for the selected particular question item.

15. A request pick-up assisting method according to claim 11, further comprising presenting, when the question item information is given in a form of a text, a text in which one of words of each question item in the given text is replaced with a connection word that is associated with a word of a corresponding question item.

16. A recording medium having recorded thereon a request pick-up assisting program for causing a control unit of an information processing device to function as:
question information registering means for registering a question item and attributes of a questionee as question information;
basic connection word candidate extracting means for referring to information that includes words constituting the question item and that is obtained from a database that collects and accumulates arbitrary text information, and extracting, as basic connection word candidates, a group of words that coexist with the words of the question item;
attribute connection word candidate extracting means for referring to information that includes words constituting the question item and that is obtained from the database, and information that includes words constituting the attributes of the questionee and that is obtained from the database, and extracting, for each attribute, as attribute connection word candidates, a group of words in which the words of the question item and the words of the attributes coexist;
attribute specificity calculating means for calculating for each attribute an attribute specificity, based on dissimilarity between a group of words that are the basic connection word candidates and groups of words that are the attribute connection word candidates;
effective attribute extracting means for comparing the attribute specificity which is calculated for each attribute, and extracting a suitable attribute;
connection word extracting means for extracting a connection word from attribute connection word candidates about the extracted effective attribute;
association chart creating means for generating an association chart which associates words that help the questionee recall a situation relevant to the question item, by referring to the extracted connection word; and
outputting means for presenting the generated association chart to a questioner in a recognizable manner.

17. A recording medium according to claim 16, wherein the request pick-up assisting program causes the attribute specificity calculating means to operate so as to treat each of a group of words included among the basic connection word candidates and groups of words included among the attribute connection word candidates for respective attributes as a set, and to calculate the attribute specificity based on a proportion of union sets to intersection sets, with how few duplicates are contained in two opposed word groups as an index of the attribute specificity.

18. A recording medium according to claim 16,
wherein the database comprises a group of texts on the Internet,
wherein the request pick-up assisting program causes the basic connection word candidate extracting means to operate so as to extract, as basic connection information, a text information group that is output as a result of a Web search using a keyword about question item information registered as the question information, or an AND Web search using a plurality of question item keywords, and
wherein the request pick-up assisting program causes the attribute connection word candidate extracting means to operate so as to extract, as attribute connection information, a text information group that is output as a result of an AND Web search using the question item keywords registered as the question information and the attributes keywords registered as the question information.

19. A recording medium according to claim 16, wherein, when there is a connection word common to the association chart for one question item and the association chart for another question item, the request pick-up assisting program causes the outputting means to operate so as to display a graph that links only the question items and the common connection word and, when a particular question item is selected, to present the association chart for the selected particular question item.

20. A recording medium according to claim 16, wherein, when the question item information is given in a form of a text, the request pick-up assisting program causes the outputting means to operate so as to present a text in which one of words of each question item in the given text is replaced with a connection word that is associated with a word of a corresponding question item.
